(19) United States
(12) Patent Application Publication
(10) Pub. No.: US 2005/0283619 A1
(43) Pub. Date: Dec. 22, 2005

(54) Managing access permission to and authentication between devices in a network

(75) Inventor: Ku Bong Min, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/155,917

(22) Filed: Jun. 15, 2005

(30) Foreign Application Priority Data
Jun. 16, 2004 (KR) 10-2004-0044698

(51) Int. Cl. H04K 1/00

(52) U.S. Cl. 713/182

(57) ABSTRACT

An accessing method for providing access to a device connected to a network comprises, in a first application, assigning access permission to at least one of a plurality of second applications, the access permission allowing access to at least one service provided by the device. The method also comprises, in the at least one of the plurality of second applications, using the access permission to request an action on the service provided by the device. The access permission may specify at least one of a state variable read-mode, a state variable write-mode, and a full action permission mode. The full action permission mode may indicate that access to all actions on the service is allowed. The method may further comprise, in the first application, assigning the access permission at approximately the same time the device is initially connected to the network.

### CROSS-REFERENCE TO RELATED APPLICATIONS

Pursuant to 35 U.S.C. § 119(a), this application claims the benefit of earlier filing date and right of priority to Korean Application No. 10-2004-0044696, filed on Jun. 16, 2004, the contents of which are hereby incorporated by reference herein in their entirety.

### FIELD OF THE INVENTION

The present invention relates generally to a networking system and, more particularly, to network access and authentication.

### BACKGROUND OF THE INVENTION

High-end digital audio/video electronic appliances such as digital video disk (DVD) players and personal computers (PCs) are becoming increasingly popular. Accordingly, user demand has increased for communication between these and other appliances found in the home with an outside network. There has also been an increasing demand to provide consumers with the ability to control home appliances using a mobile apparatus, such as a personal direct access (PDA) device.

In an attempt to satisfy these demands, several types of home networks have been designed. For example, universal plug and play (UPnP) technology has been proposed as a technology to be used for home networking.

The UPNP architecture is a distributed, open networking architecture that leverages standard networking technologies, such as internet protocol (IP) and hypertext transfer protocol (HTTP) to accomplish data transfer between networked devices in the home or office. The UPNP architecture may be implemented independently from specific operating systems, platforms, and transmission media.

In operation of UPNP technology, service-providing devices (devices) in a network are discovered automatically. Each service provided by a network device is modeled as an action with state variables. The service is requested and invoked by other devices using a control point application. The control point application may be installed on a single UPnP device, which conducts other services as well, or may be installed on each of a plurality of UPnP devices.

The UPNP technology offers authentication and security functions necessary for establishing a secure channel between a control point application and devices in an UPNP network. The security function includes message identification, message authentication information (such as a sender's certificate), as well as message encryption.

FIG. 1 is a diagram illustrating a universal plug and play (UPnP) audio visual (AV) network. Referring to FIG. 1, an AV media renderer 110 and an AV media server 120 are authenticated by an AV control point 130. After successful authentication, the media renderer 110 and the AV media server 120 may securely communicate with each other.

FIG. 2 is a diagram illustrating an UPnP network for supporting remote user interface. Referring to FIG. 2, an UPnP network includes a remote user interface (Remote UI) enabled control point 230, a Remote UI client 210 and a Remote UI server 220. The Remote UI client 210 and the Remote UI server 220 are authenticated by the Remote UI control point 230. After successful authentication, a secure channel between the Remote UI client 210 and the Remote UI server 220 is established for information exchange.

In the networks illustrated in FIGS. 1 and 2, it is preferred that the media renderer 110 (or 210) is authenticated by the media server 120 (or 220) for the media renderer 110 (or 210) to access contents in the media server 120 (or 220). Permission to access (access permission) the contents in the media server 120 (or 220) is assigned on a content by content basis or by a group of contents.

FIG. 3 is a diagram illustrating a procedure for authentication between a server and a client. Referring to FIG. 3, to enable authentication between devices which have not been specified in the UPnP specification, a password-based authentication may be used. A client device 310 sends an identification (ID) and a password to a server device 320 to acquire permission to access desired content on the server device 320.

However, the security of the communication channel described with respect to FIG. 3, is very weak as compared to a strong secure channel between control points and devices via UPnP security. The security weakness may allow the contents to be accessed by unauthorized devices in the network.

### SUMMARY OF THE INVENTION

Accordingly, the present invention is directed to managing access permission to and authentication between devices in a network that substantially obviates one or more problems due to limitations and disadvantages of the related art.

An object of the present invention is to provide authentication between devices in an UPnP network via a secure control point application to establish a secure communication channel between the devices.

It is another object of the present invention to enable a control point application to invoke actions on secure services provided by a device in an UPnP network after secured authentication is completed.

It is another object of the present invention to provide setting and granting of access permission of each of a plurality of devices in an UPnP network and/or services provided by each of a plurality of devices, to each of a plurality of control points.

According to the present invention, after a security console application authenticates a control point application, the control point application may request an action by a secure service on a device in an UPnP network, based on authentication information generated by the security console application.

According to the present invention, after a security console application assigns access permission of a service on one device in an UPnP network to a control point application, the control point application may request an action by the service on the device.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, in one embodiment, an accessing method for providing access to a device connected to a network comprises, in a first application, assigning access permission to at least one of a plurality of second applications, the access permission allowing access to at least one service provided by the device. The method also comprises, in the at least one of the plurality of second applications, using the access permission to request an action on the service provided by the device.

The access permission may specify at least one of a state variable read-mode, a state variable write-mode, and a full action permission mode. The full action permission mode may indicate that access to all actions on the service is allowed. The method may further comprise, in the first application, assigning the access permission at approximately the same time the device is initially connected to the network. The access permission may be determined based on a user input entered to the security application.

The method may further comprise assigning the access permission by sending of an access certificate to the at least one of the plurality of second applications, the access certificate specifying the access permission on the service provided by the device. The access certificate may comprise at least one of a signer, a signed date, an access permission mode, and keys for encryption/decryption. The method may further comprise, in the first application, sending the access certificate at approximately the same time as a request for an action on the at least one device is sent by the at least one of the plurality of second applications.

The method may further comprise assigning the access permission by sending an access authorization list to the device, the access authorization list specifying access permission to the device for all of the plurality of second applications. The access permissions on services provided by the device may be specified in the access authorization list for each of the plurality of second applications. The action on the service provided by the device may comprise reading a password created by the at least one device. The device may be a server device containing media files.

The action on the service provided by the device may comprise writing a password to the device, the password having being one of created by the first application and received from outside the network. The device may be one of a server device containing media files and a client device requesting transfer of the media files to the server device.

In another embodiment, an accessing method for providing access to a device connected to a network comprises, in a first application, assigning access permission to at least one of a plurality of second applications, the access permission allowing access to at least one service provided by the device. The method also comprises, in the at least one of the plurality of second applications, using the access permission to request an action on the service provided by the device. The access permission comprises a one-time password created by one of the first application and the device.

In yet another embodiment, an accessing method for providing access to a device connected to a network comprises, in a security application, assigning access permission to a service provided by the device to a control application, the access permission specifying a full permission indicative of allowance of all actions on services provided by the device. The accessing method also comprises, in the control application, requesting an action on the service provided by the device to the device after the assigning of access permission.

In still another embodiment, an accessing method for providing access to a plurality of devices connected to a network comprises, in a security application, assigning access permission to a service provided by a first device of the plurality of devices to a control application, and assigning access permission to a service provided by a second device of the plurality of devices to the control application, an assigned access permission to the service provided by the first device including at least a state variable read-mode, an assigned access permission to the service provided by the second device including at least a state variable write-mode. The method also comprises, in the control application, requesting an action on a service provided by the first device or the second device after the assigning of access permission. The state variable may be a one-time password created by one of the first device, the second device, and the control application.

In yet another embodiment, a networked apparatus including a plurality of devices comprises a first application configured to request a control or inquiry action to the plurality of devices or services provided by the plurality of devices, the control application running on one of the plurality of devices. The networked apparatus also comprises a second application communicatively coupled to the control application, configured to assign access permission to services provided by the plurality of devices to the control application, the security application running on one of the plurality of devices. When a device of the plurality of devices is initially connected to a network, the first application may send an access certificate to at least one of a plurality of control applications, the access certificate specifying access permission to services provided by the plurality of devices. Alternatively, when a device of the plurality of devices is initially connected to a network, the first application may send an access certificate to the device of the plurality of devices, the access certificate specifying, for at least one of a plurality of security applications, an access permission on a service provided by the device of the plurality of devices. The second application may request the control or inquiry action on a service provided by one of the plurality of devices, based on the access permission assigned by the first application.

In still another embodiment, a networked apparatus including a plurality of devices comprises a control application configured to request a control or inquiry action to the plurality of devices or services provided by the plurality of devices, the control application running on one of the plurality of devices. The networked apparatus also comprises a security application communicatively coupled to the control application, configured to assign an access permission to services provided by the plurality of devices to the control application, the access permission specifying a full action permission mode indicative of allowance of all actions on services provided by the plurality of devices, the security application running on one of the plurality of devices.

The foregoing and other objects, features, aspects and advantages of the present invention will become more apparent from the following detailed description of the present invention when taken in conjunction with the accompanying drawings. It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention.

FIG. 1 is a diagram illustrating a universal plug and play (UPnP) audio visual (AV) network.

FIG. 2 is a diagram illustrating an UPNP network for supporting remote user interface.

FIG. 3 is a diagram illustrating a procedure for authentication between a server and a client.

FIG. 4 is a diagram illustrating a procedure for assigning access permission to a secure device to a control point application, at a security console application, according to an embodiment of the present invention.

FIG. 5 is a diagram illustrating a procedure for authentication between two secure devices via a control point application, according to an embodiment of the present invention.

FIG. 6 is a diagram illustrating a procedure for authentication between two secure devices via a control point application, according to another embodiment of the present invention.

FIGS. 7 to 9 are diagrams illustrating structures of actions for password-based authentication between a control point application and a secure device, according to various embodiments of the present invention.

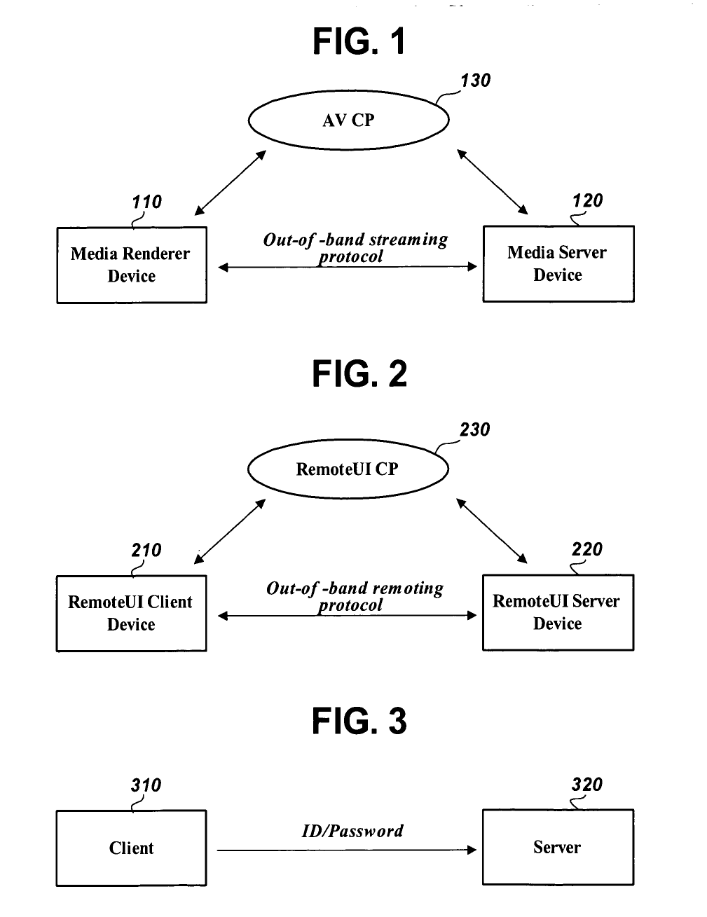

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

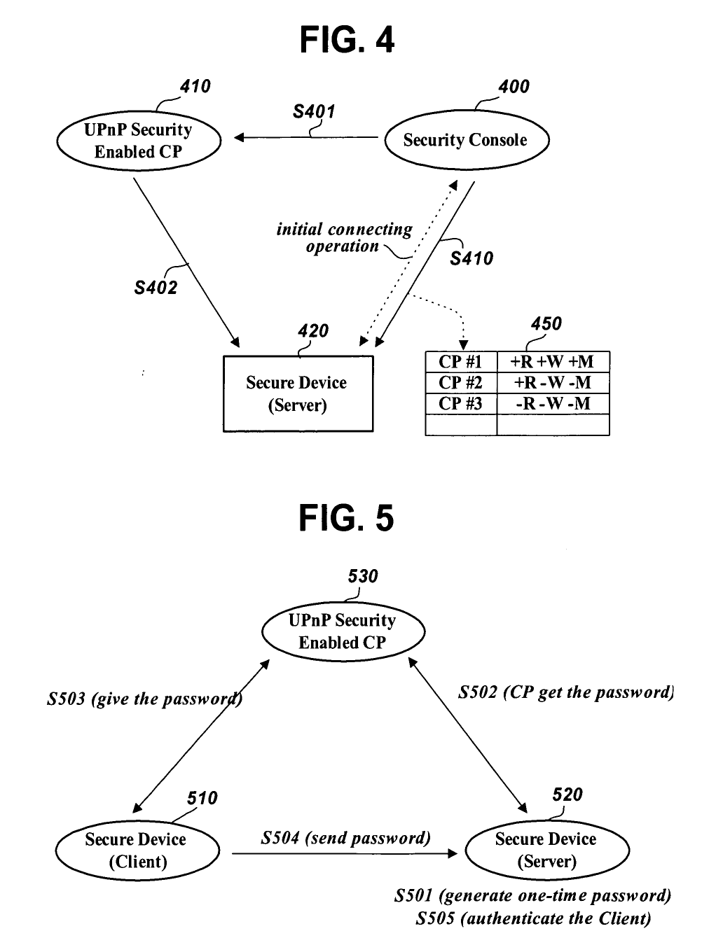

FIG. 4 is a diagram illustrating a procedure for assigning permission to access a secure device 420 (access permission) to a control point application 410 by a security console application 400, according to an embodiment of the present invention.

Referring to FIG. 4, an exemplary procedure for how a control application, e.g., a control point 410, obtains access permission to actions on secure devices 420 in a universal plug and play (UPnP) network is described. To enable secure communication based on UPnP technology, an UPnP network is configured such that a secure device 420 has a DeviceSecurity service. A control point (control point application) 410 may invoke the DeviceSecurity service action.

Access permission to the secure device 420 may be granted to the control point 410 using a security console application (security console) 400 to send an access certificate specifying access permission to the secure device 420 for the control point 410. Alternatively, the control point 410 may be granted access permission to the secure device 420 by assigning an access authorization list to the secure device 420 that specifies what actions each control point is allowed to perform on the secure device 420. The access authorization list may be sent to each device in the UPnP network by the security console 400. Granting of access permission to the secure device 420 may be performed after the security console 400 has authenticated the control point 410 via the UPnP security. The authentication of the control point 410 by the security console 400 may be required to request and invoke secure actions on the UPNP devices. The authentication procedure may be similar to the authentication procedure conducted when a device is initially connected to the UPNP network, as described below.

The control point 410 and the security console 400 may be implemented in separate devices. Alternatively, the control point 410 and the security console 400 may be embedded in a single device, e.g., a media renderer for providing a media rendering service.

In one embodiment, in a procedure for granting access permission of UPnP devices by the security console 400, the secure device 420 may be connected to an UPnP network, and the security console 400 may detect the connection of the secure device 420 to the UPnP network. The security console 400 may then request a user to enter information required to determine the owner of the secure device 420. In response to the request from the security console 400, the user may enter the information into the security console 400 by, for example, referencing ownership information on a manual or a label on the secure device 420. Upon receipt of the ownership information from the user, the security console 400 may send the ownership information to the secure device 420. The secure device 420 may determine whether or not the ownership information received from the security console 400 is correct. That is, the secure device 420 may determine whether the received ownership information matches the ownership information stored in the secure device 420. If the ownership information is correct (matches), the security console 400 may become owner of the secure device 420. The security console 400 may perform a series of authentication processes including exchanging and sharing signer information and encryption keys. In so doing, the security console 400 may gain full access permission of the device 400.

In another embodiment, after the device 420 is initially authenticated by the security console 400, the security console 400 may assign access permission of the security device 420 to the control point application 410.

In yet another embodiment, access permission is sent to the control point 410 by the security console 400. A user may enter access permission information via a user interface (UI) provided in the security console 400. The access permission information may specify access permission to the secure device 420, or action on services (secure services) provided by the secure device 420, for each control point. Based on the access permission information, the security console 400 may send an access certificate to all control points running in the UPnP network, including the control point 410 (S401). The access certificate may include an identification of the security console (as a signer), a sign date, keys for encryption/decryption, and access permission to the secure device 420 or actions on the services provided by the secure device 420. Actions on the services provided by the secure device 420, may include for example, a read-mode, a write-mode, and a requestable mode, such as for example, including rights to read and/or write the device state and the types of actions requested.

The access certificate may be stored in the control point 410. The access certificate may be sent from the control point 410 to the secure device 420 to invoke an action on secure services provided by the secure device 420 (S402). For example, when read-only mode is set in the access certificate, if the control point 410 requests an action requiring a write operation, the secure device 420 may decrypt the access certificate using, for example, a public key. The secure device 420 may then deny the request for an action requiring a write operation by the control point 410, because the write action was not authorized by the access certificate. Thus, requests for actions not authorized by the access certificate may be rejected by the secure device 420. Furthermore, actions provided by the secure device 420 are inaccessible to control points not listed in the access permission information because such control points do not have an appropriate access certificate to send to the secure device 420. The secure device 420 may deny action requests not accompanied by an appropriate access certificate. Thus, the sending of an appropriate access certificate to a control point may serve as the authentication process for the control points.

In still another embodiment, an access authorization list is sent to the secure device 420 for the granting of access permission to the secure device. A user interface (UI) provided in the security console 400 may allow a user to enter access permission information that specifies, for each of a plurality of control points, access permission to the secure device 420 or services provided by the secure device 420. Based on the access permission information, the security console 400 may compose and send an access authorization list 450 to the secure device 420 via UPNP security (S410). Each entry in the access authorization list 450 may correspond to each of the plurality of control points and may specify access permission to the secure device 420 or a set of services provided by the secure device 420.

In the embodiment, sending an access certificate from a control point to a desired device to request an action provided by the device, or a service provided by the device, may not be required. The secure device 420 may receive a request of action from the control point 410, and may determine whether or not the action requested by the control point 410 is allowable, based on the access permission of the control point 410 specified in the access authorization list. The secure device 420 may then reject or accept the action based on a result of the determination, accordingly.

Control points with no access permission to the secure device 420 may not be specified in the access authorization list 450. Control points that are not specified in the access authorization list 450 are preferably not capable of invoking an action on the secure device 420 or on a service provided by the secure device 420.

Thus, for a control point to request an action on the secure device 420 or a service on the secure device 420, an appropriate access permission may be designated by the security console 400. The appropriate access permission may be the access authorization list.

In yet another embodiment, a procedure in which the control point 410 requests invocation of an action provided by the secure device 420 via UPNP security includes establishing a secure communication channel between the control point 410 and the secure device 420 by, for example, exchanging private and public keys. When the control point 400 invokes an action provided by the secure device 410, an action request may be digitally signed or encrypted using the private key. The action request may then be sent to the secure device 410 as an argument of a DecryptAndExecute action. The secure device 420 may also receive the action request and decrypt the argument of the DecryptAndExecute action using the public key.

With reference to granting access permission to control points for each of a plurality of devices via UPNP security, authentication methods for establishing communication between devices are described in detail below.

FIG. 5 is a diagram illustrating a procedure for authentication between two secure devices via a control point application, according to an embodiment of the present invention. FIGS. 7 to 9 are diagrams illustrating structures of actions for password-based authentication between a control point application and a secure device, according to various embodiments of the present invention.

Referring to FIG. 5, an embodiment of a one-time password-based authentication method between devices is described. As shown in FIG. 5, a secure channel is established via a control point, such as for example, an UPNP security enabled Remote UI control point 530, between a secure client device (client) 510 and a secure server device (server) 520. The secure client device 510 may be required to provide authentication to the server 520.

The server 520 may generate a one-time password (password) (S501). After authentication between devices is completed, the password may be invalidated or expire automatically to prevent non-secure connections. The UPnP security enabled control point 530 may receive the password as a ‘Secret’ argument (see FIG. 8) by invoking (requesting) a “GetSecret” action (see FIG. 7) (S502). In response to the request for the “GetSecret” action by the control point 530, the server 520 may send the one-time password to the control point 530. The one-time password may be kept as a state variable in the server 520. Therefore, the “GetSecret” action may read a state variable. The ‘Req’ mark (see FIG. 7) may imply that actions described with reference to FIG. 7 are required to enable authentication between devices via secure channels between a control point and UPNP devices.

The control point 530 may receive the one-time password from the server 520, and may transfer the password as a ‘Secret’ argument (see FIG. 9) to the secure client device 510 using a “SetSecret” action (see FIG. 7) (S503). The secure client device 510 may be, for example, a media renderer. The “SetSecret” action may set or change a state variable in response to the client 510 setting the password as its state variable. The requests of “GetSecret” and “SetSecret” actions may be encrypted with the private key and may be carried as arguments of the DecryptAndExecute action on the DeviceSecurity service provided by the secure client and server devices 510 and 520.

Upon receiving the password from the control point 530, the client 520 may forward the password to the server 520 (S504). The server 520 may determine whether or not to authenticate the client 510 by comparing the password received from the server 520 against the one-time password created by the server 520 (S505).

Thus, a secure channel may be established between the two secure devices 510 and 520 through creation of a one-time password by the server 520 and sending of the one-time password to the client 510 from the server 520, using a strong secure channel via the UPnP security enabled control point 530. The client device 510 may be authenticated in the server 520 by comparing the password sent from the client device 510 to the server 520 against the one-time password created by the server 520.

When the security console 400 sets access permission to the secure devices 510 and 520 for the control point 530 using the access authorization lists, in order for the control point 530 to invoke a GET action on the server 520 and a SET action on the client 510, access permissions by the control point 530 for the server 520 and the client 510 may be set to include at least a read-mode and at least a write-mode, respectively.

The access authorization lists of the two secure devices 510 and 520 may be set to provide the control point 530 with full access permission to invoke all actions on the services provided by the two secure devices 510 and 520. Alternatively, the access authorization lists may be constructed so that the “GetSecret” action is included in a list of accessible actions provided by the server 520 and the “SetSecret” action is included in a list of accessible actions provided by the client 510. The access authorization list of the secure devices 510 and 520 may be provided by a device vendor in the form of a profile.

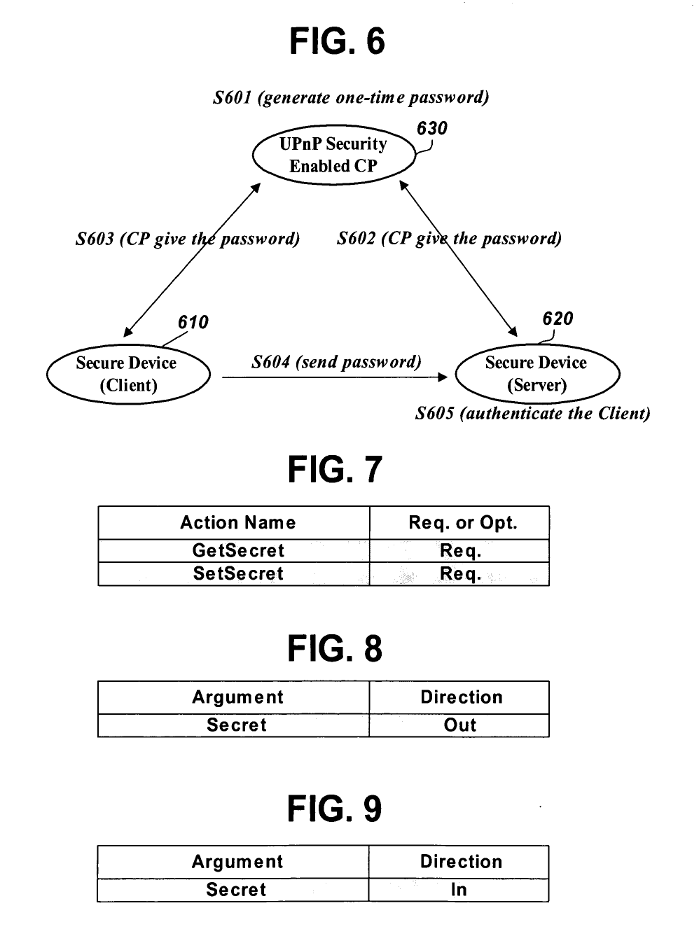

FIG. 6 is a diagram illustrating a procedure for authentication between two secure devices via a control point application, according to another embodiment of the present invention.

Referring to FIG. 6, an UPNP security enabled control point 610 generates a one-time password (S601) and sends the password to a client 610 and a server 620 as a ‘Secret’ argument (see FIG. 9) using a “SetSecret” action (see FIG. 7) (S603, S602). Requests of a “SetSecret” action may be encrypted and carried as arguments of a DecryptAndExecute action on the DeviceSecurity service on the secure devices 610 and 620.

After receipt of the password from the control point 630, the client 610 may send the password to the server 620 (S604). The server 620 may determine whether or not to authenticate the client 610 by comparing the password received from the client 610 against the password received from the control point 630 (S605).

Thus, a secure channel may be established between two secure devices through creation of a password by a control point and sending the password to the two secure devices. Among the two secure devices, a client device may send the password to a server device, and the server device may authenticate the client device by comparing the password received from the client device against the password created by the control point.

In the embodiment, in order for the control point 630 to invoke SET actions on the server 620 and the client 610, access permissions by the control point 630 for the server 620 and the client 610 may be set to include at least a write-mode.

The access authorization lists of the two secure devices 610 and 620 may be set to provide the control point 630 with full access permission to invoke any actions on the services provided by the two secure devices 610 and 620. Alternatively, the access authorization lists may be composed such that the SetSecret action is included in accessible actions on the client 610 and the server 620.

Thus, a secure channel may be established between control points and a plurality of devices via UPnP security, with authentication between two secure devices via the secure channel.

In one embodiment, an accessing method for providing access to a device connected to a network comprises, in a first application, assigning access permission to at least one of a plurality of second applications, the access permission allowing access to at least one service provided by the device. The method also comprises, in the at least one of the plurality of second applications, using the access permission to request an action on the service provided by the device.

The access permission may specify at least one of a state variable read-mode, a state variable write-mode, and a full action permission mode. The full action permission mode may indicate that access to all actions on the service is allowed. The method may further comprise, in the first application, assigning the access permission at approximately the same time the device is initially connected to the network. The access permission may be determined based on a user input entered to the security application.

The method may further comprise assigning the access permission by sending of an access certificate to the at least one of the plurality of second applications, the access certificate specifying the access permission on the service provided by the device. The access certificate may comprise at least one of a signer, a signed date, an access permission mode, and keys for encryption/decryption. The method may further comprise, in the first application, sending the access certificate at approximately the same time as a request for an action on the at least one device is sent by the at least one of the plurality of second applications.

The method may further comprise assigning the access permission by sending an access authorization list to the device, the access authorization list specifying access permission to the device for all of the plurality of second applications. The access permissions on services provided by the device may be specified in the access authorization list for each of the plurality of second applications. The action on the service provided by the device may comprise reading a password created by the at least one device. The device may be a server device containing media files.

The action on the service provided by the device may comprise writing a password to the device, the password having being one of created by the first application and received from outside the network. The device may be one of a server device containing media files and a client device requesting transfer of the media files to the server device.

In another embodiment, an accessing method for providing access to a device connected to a network comprises, in a first application, assigning access permission to at least one of a plurality of second applications, the access permission allowing access to at least one service provided by the device. The method also comprises, in the at least one of the plurality of second applications, using the access permission to request an action on the service provided by the device. The access permission comprises a one-time password created by one of the first application and the device.

In yet another embodiment, an accessing method for providing access to a device connected to a network comprises, in a security application, assigning access permission to a service provided by the device to a control application, the access permission specifying a full permission indicative of allowance of all actions on services provided by the device. The accessing method also comprises, in the control application, requesting an action on the service provided by the device to the device after the assigning of access permission.

In still another embodiment, an accessing method for providing access to a plurality of devices connected to a network comprises, in a security application, assigning access permission to a service provided by a first device of the plurality of devices to a control application, and assigning access permission to a service provided by a second device of the plurality of devices to the control application, an assigned access permission to the service provided by the first device including at least a state variable read-mode, an assigned access permission to the service provided by the second device including at least a state variable write-mode. The method also comprises, in the control application, requesting an action on a service provided by the first device or the second device after the assigning of access permission. The state variable may be a one-time password created by one of the first device, the second device, and the control application.

In yet another embodiment, a networked apparatus including a plurality of devices comprises a first application configured to request a control or inquiry action to the plurality of devices or services provided by the plurality of devices, the control application running on one of the plurality of devices. The networked apparatus also comprises a second application communicatively coupled to the control application, configured to assign access permission to services provided by the plurality of devices to the control application, the security application running on one of the plurality of devices. When a device of the plurality of devices is initially connected to a network, the first application may send an access certificate to at least one of a plurality of control applications, the access certificate specifying access permission to services provided by the plurality of devices. Alternatively, when a device of the plurality of devices is initially connected to a network, the first application may send an access certificate to the device of the plurality of devices, the access certificate specifying, for at least one of a plurality of security applications, an access permission on a service provided by the device of the plurality of devices. The second application may request the control or inquiry action on a service provided by one of the plurality of devices, based on the access permission assigned by the first application.

In still another embodiment, a networked apparatus including a plurality of devices comprises a control application configured to request a control or inquiry action to the plurality of devices or services provided by the plurality of devices, the control application running on one of the plurality of devices. The networked apparatus also comprises a security application communicatively coupled to the control application, configured to assign an access permission to services provided by the plurality of devices to the control application, the access permission specifying a full action permission mode indicative of allowance of all actions on services provided by the plurality of devices, the security application running on one of the plurality of devices.

The present invention may provide access-controlling of each of a plurality of devices in an UPNP network by enabling grants of access permissions of the plurality of devices to a plurality of control points. The present invention also may provide establishment of a secure and reliable communication channel between two secure devices by enabling performance of authentication between the two secure devices using a strong secure channel between control points and devices. Furthermore, because a one-time password may be used in the authentication process, which may expire automatically after a first use, non-secure connections may be prevented even if the password is leaked.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

1. An accessing method for providing access to a device connected to a network, the method comprising:
in a first application, assigning access permission to at least one of a plurality of second applications, the access permission allowing access to at least one service provided by the device; and
in the at least one of the plurality of second applications, using the access permission to request an action on the service provided by the device.

2. The method of claim 1, wherein the access permission specifies at least one of: a state variable read-mode, a state variable write-mode, and a full action permission mode.

3. The method of claim 2, wherein the full action permission mode indicates that access to all actions on the service is allowed.

4. The method of claim 1, further comprising:
in the first application, assigning the access permission at approximately the same time the device is initially connected to the network.

5. The method of claim 1, wherein the access permission is determined based on a user input entered to the security application.

6. The method of claim 1, further comprising:
assigning the access permission by sending of an access certificate to the at least one of the plurality of second applications, the access certificate specifying the access permission on the service provided by the device.

7. The method of claim 6, wherein the access certificate comprises at least one of a signer, a signed date, an access permission mode, and keys for encryption/decryption.

8. The method of claim 6, further comprising:
in the first application, sending the access certificate at approximately the same time as a request for an action on the device is sent by the at least one of the plurality of second applications.

9. The method of claim 1, further comprising:
assigning the access permission by sending an access authorization list to the device, the access authorization list specifying access permission to the device for all of the plurality of second applications.

10. The method of claim 9, wherein access permissions on services provided by the device are specified in the access authorization list for each of the plurality of second applications.

11. The method of claim 1, wherein the action on the service provided by the device comprises reading a password created by the device.

12. The method of claim 1, wherein the device is a server device containing media files.

13. The method of claim 1, wherein the action on the service provided by the device comprises writing a password to the device, the password being one of created by the first application and received from outside the network.

14. The method of claim 13, wherein the device is one of a server device containing media files and a client device requesting transfer of the media files to a server device.

15. The method of claim 14, wherein the first application is a security application and the second application is a control application.

16. An accessing method for providing access to a device connected to a network, the method comprising:
in a first application, assigning access permission to at least one of a plurality of second applications, the access permission allowing access to at least one service provided by the device; and
in the at least one of the plurality of second applications, using the access permission to request an action on the service provided by the device,
wherein the access permission comprises a one-time password created by one of the first application and the device.

17. An accessing method for providing access to a device connected to a network, the method comprising:
in a security application, assigning access permission to a control application to enable access to a service provided by the device, the access permission specifying a full permission indicative of allowance of all actions on services provided by the device; and
in the control application, requesting an action to the device for the service provided by the device after the assigning of access permission.

18. The method of claim 17, wherein the access permission comprises a state variable comprising a one-time password created by one of the first device, the second device, and the control application.

19. A networked apparatus including a plurality of devices, comprising:
a first application configured to request a control or inquiry action to the plurality of devices or services provided by the plurality of devices, the first application running on one of the plurality of devices; and
a second application communicatively coupled to the first application, configured to assign access permission to services provided by the plurality of devices to the first application, the second application running on one of the plurality of devices.

20. The networked apparatus of claim 19, wherein the access permission specifies at least one of: a state variable read-mode, a state variable write-mode, and a full action permission mode.

21. The networked apparatus of claim 19, wherein the access permission specifies a full action permission mode indicating that all actions on the services are allowed.

22. The networked apparatus of claim 19, wherein when a device of the plurality of devices is initially connected to a network, the first application sends an access certificate to at least one of a plurality of first applications, the access certificate specifying access permission to services provided by the plurality of devices.

23. The networked apparatus of claim 22, wherein the access certificate includes at least one of a signer, a signed date, an access permission mode, and keys for encryption/decryption.

24. The networked apparatus of claim 22, wherein the access certificate is sent from the second application to one of the plurality of devices when the second application requests the control or inquiry action on the one of the plurality of devices.

25. The networked apparatus of claim 19, wherein when a device of the plurality of devices is initially connected to a network, the first application sends an access certificate to the device of the plurality of devices, the access certificate specifying, for at least one of a plurality of security applications, an access permission on a service provided by the device of the plurality of devices.

26. The networked apparatus of claim 19, wherein the state variable is a one-time password created by one of the plurality of devices or by the second application.

27. The networked apparatus of claim 19, wherein the first application requests the control or inquiry action on a service provided by one of the plurality of devices, based on the access permission assigned by the second application.

28. The networked apparatus of claim 27, wherein the action requested by the first application includes an action of reading a password created by one of the plurality of devices.

29. The networked apparatus of claim 28, wherein the device to which the action of reading a password is requested is a server device containing media files.

30. The networked apparatus of claim 27, wherein the action requested by the first application includes an action of writing a password to one of the plurality of devices, the password having been created by the first application or received from outside a network to which the networked apparatus is connected.

31. The networked apparatus of claim 30, wherein the device to which the action of writing a password is requested is a server device containing media files or a client device requesting transfer of the media files to a server device.

32. A networked apparatus including a plurality of devices, comprising:
a control application configured to request a control or inquiry action to the plurality of devices or services provided by the plurality of devices, the control application running on one of the plurality of devices; and
a security application communicatively coupled to the control application, configured to assign an access permission to the control application to enable access to services provided by the plurality of devices, the access permission specifying a full action permission mode indicative of allowance of all actions on services provided by the plurality of devices, the security application running on one of the plurality of devices.
